(19) United States
(12) Patent Application Publication
(10) Pub. No.: US 2014/0085867 A1
(43) Pub. Date: Mar. 27, 2014

(54) Reflector, Backlight Module, and Liquid Crystal Display Device Thereof

(71) Applicant: Shenzhen China Star Optoelectronics Technology Co. Ltd., Shenzhen, Guangdong (CN)

(72) Inventor: Yanxue Zhang, Shenzhen (CN)

(73) Assignee: Shenzhen China Star Optoelectronics Technology Co., Ltd, Shenzhen,Guangdong (CN)

(21) Appl. No.: 13/697,008

(22) PCT Filed: Oct. 10, 2012
(86) PCT No.: PCT/CN12/82670

§ 371 Date: Nov. 8, 2012

(30) Foreign Application Priority Data
Sep. 26, 2012 (CN) 201210363681.9

(51) Int. Cl. G02F 1/1335; F21V 7/22

(52) U.S. Cl. CPC G02F 1/133605; F21V 7/22
USPC 362/97.2; 362/97.1; 362/346

(57) ABSTRACT

The present invention provides a reflector, backlight module, and liquid crystal display device. The reflector, which includes: a first reflector element and a second reflector element. The first reflector element and the second reflector element consist of different materials; as a result, the first reflector element is more heat resistant than the second reflector element. In addition, the cost of the second reflector element is less than the cost of the first reflector element; thus, the normal function of the reflector is maintained while reducing the cost of the reflector; as a result, the cost of the backlight module and the liquid crystal display device is reduced.

### BACKGROUND OF THE INVENTION

1. Field of the Invention

The present invention relates to the field of liquid crystal displaying techniques, and in particular to a reflector, a backlight module, and a liquid crystal display device.

2. The Related Arts

Referring FIG. 1, FIG. 1 is a schematic view showing the structure of backlight module in known technique; as shown in FIG. 1, the backlight module which comprises: back plate 10, reflector 11, backlight unit 12, and lightguiding plate (not shown in on the figure); in the backlight module, the reflector being disposed under the lightguiding plate to reflect light, which leaking out from the bottom of lightguiding plate; back to the lightguiding plate to increase light utilization efficiency; as shown in FIG. 1, reflector 11 being disposed on back plate 10 and consisting of heat-resistant materials; therefore, reflector 11 being with relatively high cost.

### SUMMARY OF THE INVENTION

The technical issue to be addressed by the present invention is to provide a low-cost reflector, a low-cost backlight module, and a low-cost liquid crystal display device.

The present invention provides a backlight module, which comprises: a back plate, at least one backlight unit, and a reflector; the reflector being disposed on the back plate; the back light unit being disposed with at least one side of the reflector; the reflector comprising: a first reflector element and a second reflector element being disposed with adjacently; the first reflector element being disposed close to the backlight unit; the second reflector element being disposed to attach to the first reflector element and being away from the backlight unit; wherein the first reflector element and the second reflector element consisting of different materials; as a result, the first reflector element being more heat resistant than the second reflector element; the reflector comprising: two long sides being disposed parallely and two short sides being disposed parallely; the two short sides being disposed vertically to the two long sides; the backlight unit comprising: a first backlight unit being disposed with one of the short sides; the first reflector element being disposed with in light emitting direction of the backlight unit, and the width of the first reflector element being less than the second reflector element.

According to a preferred embodiment of the present invention, the back plate comprises: a position convex bump corresponding a via-hole which is disposed on the first reflector element; the position convex bump positioning the first reflector element through the via-hole.

According to a preferred embodiment of the present invention, double-sided tape is applied to attach the second reflector element to the back plate.

The present invention provides a backlight module, which comprises: a back plate, at least one backlight unit, and a reflector; the reflector being disposed on the back plate; the back light unit being disposed with at least one side of the reflector; the reflector comprising a first reflector element and a second reflector element being disposed with adjacently; the first reflector element being disposed close to the backlight unit; the second reflector element being disposed to attach to the first reflector element and being away from the backlight unit; wherein the first reflector element and the second reflector element consisting of different materials; as a result, the first reflector element being more heat resistant than the second reflector element.

According to a preferred embodiment of the present invention, the reflector comprises: two long sides being disposed parallely and two short sides being disposed parallely; the two short sides being disposed vertically to the two long sides; the backlight unit comprises: a first backlight unit being disposed with one of the short sides.

According to a preferred embodiment of the present invention, the reflector comprises: two long sides being disposed parallely and two short sides being disposed parallely; the two short sides being disposed vertically to the two long sides; the backlight unit comprises: a first backlight unit being disposed with one of the long sides.

According to a preferred embodiment of the present invention, the reflector comprises: two long sides being disposed parallely and two short sides being disposed parallely; the two short sides being disposed vertically to the two long sides; the backlight unit comprising: a first backlight unit and a second backlight being disposed at the outer edges of two short sides respectively; the second reflector element being disposed in between two first reflector elements.

According to a preferred embodiment of the present invention, the reflector comprises: two long sides being disposed parallely and two short sides being disposed parallely; the two short sides being disposed vertically to the two long sides; the backlight unit comprises: a first backlight unit and a second backlight being disposed at the outer edges of two long sides respectively; the second reflector element being disposed in between two first reflector elements.

According to a preferred embodiment of the present invention, the first reflector element is disposed with in light emitting direction of the backlight unit; the width of the first reflector element being less than the second reflector element.

According to a preferred embodiment of the present invention, the back plate comprises: a position convex bump corresponding a via-hole which is disposed on the first reflector element; the position convex bump positioning the first reflector element through the via-hole.

According to a preferred embodiment of the present invention, double-sided tape is applied to attach the second reflector element to the back plate.

The present invention provides a liquid crystal display device, which comprises: a backlight module comprising a back plate, at least one backlight unit, and a reflector; the reflector being disposed on the back plate; the back light unit being disposed with at least one side of the reflector; the reflector comprising: a first reflector element and a second reflector element being disposed with adjacently; the first reflector element being disposed close to the backlight unit; the second reflector element being disposed to attach to the first reflector element and being away from the backlight unit; wherein the first reflector element and the second reflector element consisting of different materials; as a result, the first reflector element being more heat resistant than the second reflector element.

According to a preferred embodiment of the present invention, the reflector comprises: two long sides being disposed parallely and two short sides being disposed parallely; the two short sides being disposed vertically to the two long sides; the backlight unit comprises: a first backlight unit being disposed with one of the short sides.

According to a preferred embodiment of the present invention, the reflector comprises: two long sides being disposed parallely and two short sides being disposed parallely; the two short sides being disposed vertically to the two long sides; the backlight unit comprises: a first backlight unit being disposed with one of the long sides.

According to a preferred embodiment of the present invention, the reflector comprises: two long sides being disposed parallely and two short sides being disposed parallely; the two short sides being disposed vertically to the two long sides; the backlight unit comprises: a first backlight unit and a second backlight being disposed at the outer edges of two short sides respectively; the second reflector element being disposed in between two first reflector elements.

According to a preferred embodiment of the present invention, the reflector comprises: two long sides being disposed parallely and two short sides being disposed parallely; the two short sides being disposed vertically to the two long sides; the backlight unit comprises: a first backlight unit and a second backlight being disposed at the outer edges of two long sides respectively; the second reflector element being disposed in between two first reflector elements.

According to a preferred embodiment of the present invention, the first reflector element is disposed with in light emitting direction of the backlight unit; the width of the first reflector element being less than the second reflector element.

According to a preferred embodiment of the present invention, the back plate comprises: a position convex bump corresponding a via-hole which is disposed on the first reflector element; the position convex bump positioning the first reflector element through the via-hole.

According to a preferred embodiment of the present invention, double-sided tape is applied to attach the second reflector element to the back plate.

The present invention provides a reflector, which comprises: at least a first reflector element and a second reflector element; according to a preferred embodiment of the present invention, the first reflector element and the second reflector element consisting of different materials; as a result, the first reflector element being more heat resistant than the second reflector element.

The efficacy of the present invention is that to be distinguished from the state of the art. The reflector, the backlight module, and the liquid crystal display device of the present invention, the first reflector element and the second reflector element which consist of different materials are applied to form the reflector, wherein the first reflector element which is disposed close to the backlight unit is more heat resistant than the second reflector element which is away from the backlight unit. In addition, the cost of the second reflector element is less than the cost of the first reflector element; thus, the normal function of the reflector is maintained while reducing the cost of the reflector; as a result, the cost of the backlight module and the liquid crystal display device is reduced.

### BRIEF DESCRIPTION OF THE DRAWINGS

FIG. 1 is a schematic view showing the structure of backlight module in known technique;

FIG. 2 is a schematic view showing the structure of the liquid crystal display device according to the present invention;

FIG. 3 is a schematic view showing the partial structure of the first embodiment of the backlight module according to the present invention;

FIG. 4 is an exploded view showing the partial structure of the backlight module in FIG. 3;

FIG. 5 is an enlarged view showing the partial structure of the first reflector element positioned on the back plate in FIG. 3:

FIG. 6 is a schematic view showing the partial structure of the second embodiment of the backlight module according to the present invention;

FIG. 7 is a schematic view showing the partial structure of the third embodiment of the backlight module according to the present invention; and

FIG. 8 is a schematic view showing the partial structure of the forth embodiment of the backlight module according to the present invention.

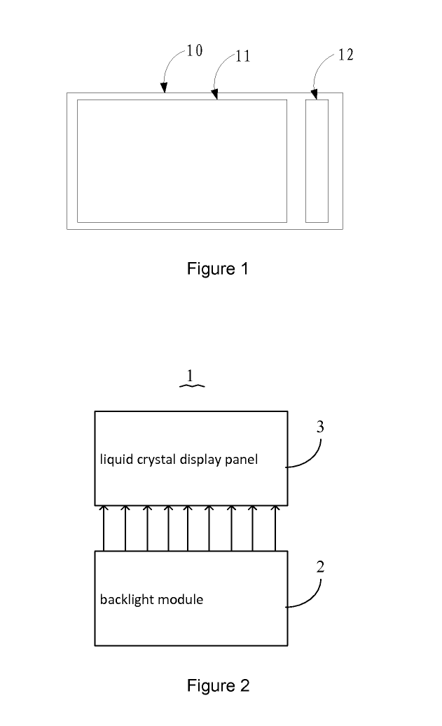

### DETAILED DESCRIPTION OF THE PREFERRED EMBODIMENTS

The following combines drawings and embodiments to describe the present invention in details.

Referring to FIG. 2, FIG. 2 is a schematic view showing the structure of the liquid crystal display device according to the present invention. As shown in FIG. 2, liquid crystal display device 1 comprises: backlight module 2 and liquid crystal display panel 3. Backlight module 2 is to provide high and a homogenous brightness light for liquid crystal display panel 3 to display images functionally.

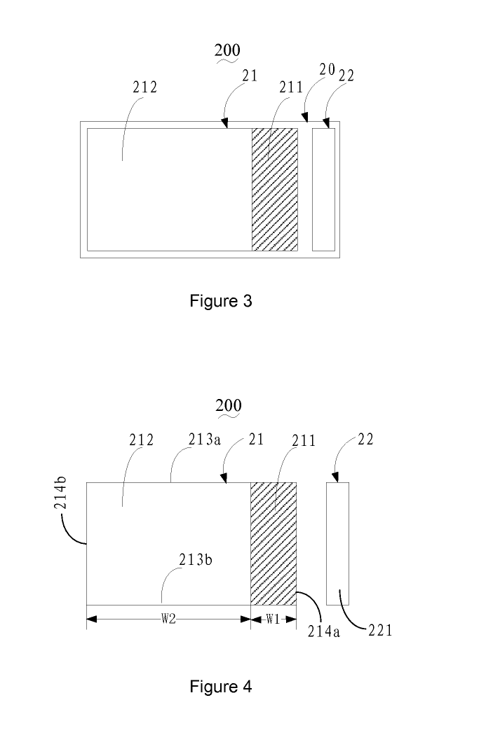

Referring to FIG. 3, FIG. 3 is a schematic view showing the partial structure of the first embodiment of the backlight module according to the present invention. As shown in FIG. 3, backlight module 200 comprises back plate 20, reflector 21, and backlight unit 22.

Back plate 20 is as braced structures for whole backlight module 200 to protect optical units, reflector 21 and backlight unit 22, of backlight module 200 and to provide the mechanical strength for backlight module 200.

Reflector 21 is disposed on back plate 20 to reflect light, which leaks out from the bottom of lightguiding plate, back to of the lightguiding plate to increase light utilization efficiency. In the instant embodiment, reflector 21 comprises: first reflector element 211 and second reflector element 212.

Backlight unit 22 which is disposed with a side of reflector 21 is a side-entering type backlight unit.

Referring to FIG. 4, FIG. 4 is an exploded view showing the partial structure of the backlight module in FIG. 3. As shown in FIG. 4, the reflector 21 comprises: two long sides 213a 213b and two short sides 214a 214b.

Two long sides 213a 213b are disposed parallely. Two short sides 214a 214b are disposed parallely. Two short sides 214a 214b are disposed vertically to two long sides 213a 213b to form a rectangle reflector 21.

Backlight unit 22 comprises: first backlight unit 221 being disposed with short side 214a.

First reflector element 211 and second reflector element 212 are disposed with adjacently. First reflector element 211 is disposed close to first backlight unit 221. Second reflector element 212 is disposed to attach to first reflector element 211 and away from first backlight unit 221.

In backlight module 200, the portion with higher temperature is around first backlight unit 221. In the instant embodiment, first reflector element 211 which is close to first backlight unit 221 is more heat resistant than second reflector element 212 which is away from first backlight unit 221.

The heat resistance of a reflector is determined by the materials used to form the reflector. In addition, the materials which provide better heat resistance are at a higher cost. In the instant embodiment, the materials of first reflector element 211 provide better heat resistance than the materials of second reflector element 212.

Furthermore, in the instant embodiment, first reflector element 211 is disposed with in light emitting direction of backlight unit 221, and width W1 of first reflector element 211 and width W2 of second reflector element 212 can be determined according to the needs. According to a preferred embodiment of the present invention, W1 is less than W2. The materials provide better heat resistance are at higher cost; thus, providing reflector 21 is in the normal function while reducing width W1, the cost of first reflector element 211 is reduced; as a result, the cost of reflector 21 is reduced.

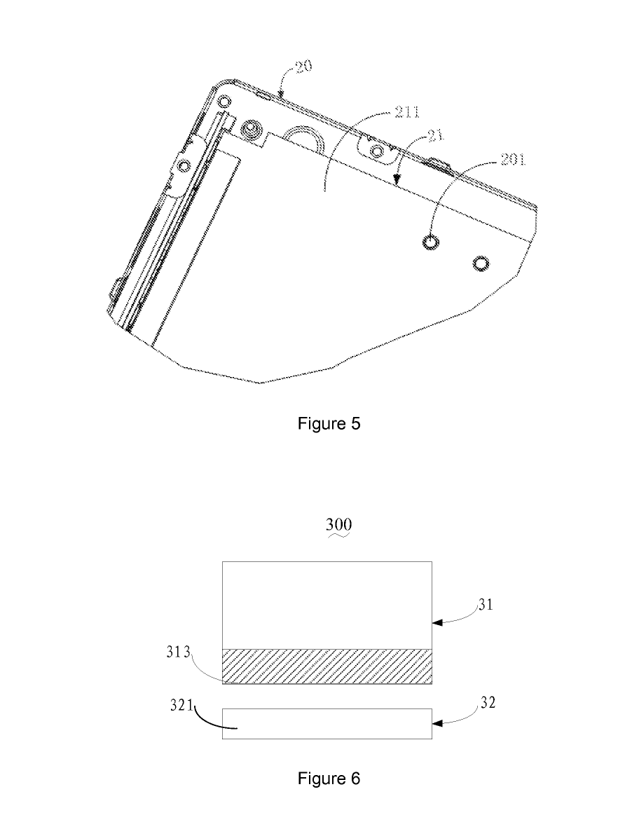

Referring to FIG. 5, FIG. 5 is an enlarged view showing the partial structure of the first reflector element positioned on the back plate in FIG. 3. As shown in FIG. 5, back plate 20 comprises: position convex bump 201 corresponding a via-hole (not shown in FIG. 5) which is disposed on first reflector element 211. Position convex bump 201 positions first reflector element 211 through the via-hole.

Position convex bump 201 is formed by stamping and disposed close to a surrounding area of back plate 20. Backlight module 200 can be divided into view area and out of viewing area. The surrounding area of back plate 20 is located on the out of viewing area of backlight module 200. Position convex bump 201 is disposed on the out of viewing area of backlight module 200; thus, the quality of optical performance of backlight module 200 is not compromised.

In the instant embodiment, double-sided tape is applied to attach second reflector element 212 to back plate 20. Double-sided tape is disposed close to the surrounding area of back plate 20; the quality of optical performance of backlight module 200 is not compromised.

Having been described, in the instant embodiment, two different materials are used for first reflector element 211 and second reflector element 212 to form reflector 21. First reflector element 211 which is disposed close to first backlight unit 221 is more heat resistant than second reflector element 212 which is disposed away from first backlight unit 221. In addition, the cost of second reflector element 212 is less than the cost of first reflector element 211; thus, providing reflector 21 is in the normal function while reducing the cost of reflector 21, as a result, the cost of backlight module 200 is reduced.

Referring to FIG. 6, FIG. 6 is a schematic view showing the partial structure of the second embodiment of the backlight module according to the present invention. As shown in FIG. 6, backlight module 300 comprises: reflector 31 and backlight unit 32.

Comparing with the embodiment shown in FIG. 3, the main differences of backlight module 300 are: Backlight unit 32 comprises: first backlight unit 321 being disposed with long side 313.

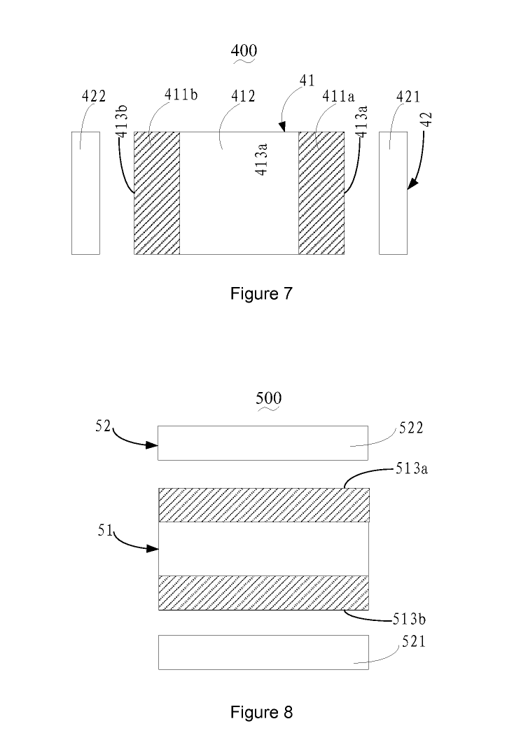

Referring to FIG. 7, FIG. 7 is a schematic view showing the partial structure of the third embodiment of the backlight module according to the present invention. As shown in FIG. 7, backlight module 400 comprises: reflector 41 and backlight unit 42.

Comparing with the embodiment shown in FIG. 3, the main differences of backlight module 400 are: Backlight unit 42 comprises: first backlight unit 421 and second backlight unit 422 being disposed at the outer edges of two short sides 413a 413b respectively.

Second reflector element 412 is disposed in between two first reflector elements 411a 411b. Two first reflector elements 411a 411b are disposed close to first backlight unit 421 and second backlight unit 422 respectively.

The materials of first reflector element 411a 411b and second reflector element 412 are different. In the instant embodiment, the material of first reflector element 411a 411b which are disposed close to first backlight unit 421 and second backlight unit 422 provides better heat-resistance. The material of second reflector element 412 provides average heat-resistance.

In another embodiment, different heat-resistance materials can be used to form two first reflector elements 411a 411b according to the temperature around first backlight unit 421 and second backlight unit 422. For example: if the temperature around first backlight unit 421 is higher than the temperature around second backlight unit 422, the better heat resistance material can be used to form first reflector elements 411a which is close to first backlight unit 421 can instead of first reflector elements 411b which is close to second backlight unit 422.

Referring to FIG. 8, FIG. 8 is a schematic view showing the partial structure of the forth embodiment of the backlight module according to the present invention. As shown in FIG. 8, backlight module 500 comprises: reflector 51 and backlight unit 52.

Comparing with the embodiment shown in FIG. 6, the main differences of backlight module 500 are: backlight unit 52 comprises: first backlight unit 521 and second backlight unit 522 being disposed at the outer edges of two long sides 513a 513b respectively.

The efficacy of the present invention is that to be distinguished from the state of the art. The reflector, the backlight module, and the liquid crystal display device of the present invention, the first reflector element and the second reflector element which consist of different materials are applied to form the reflector. The first reflector element which is disposed close to the backlight unit is more heat resistant than the second reflector element which is away from the backlight unit. In addition, the cost of the second reflector element is less than the cost of the first reflector element; thus, the present invention provides the normal function of the reflector while reducing the cost of the reflector; as a result, the cost of the backlight module and the liquid crystal display device is reduced.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A backlight module, which comprises:
a back plate, at least one backlight unit, and a reflector; wherein
the reflector being disposed on the back plate;
the back light unit being disposed with at least one side of the reflector;
the reflector comprising: a first reflector element and a second reflector element being disposed with adjacently;
the first reflector element being disposed close to the backlight unit;
the second reflector element being disposed to attach to the first reflector element and being away from the backlight unit;
wherein the first reflector element and the second reflector element consisting of different materials;
as a result, the first reflector element being more heat resistant than the second reflector element;
the reflector comprising: two long sides being disposed parallely and two short sides being disposed parallely;
the two short sides being disposed vertically to the two long sides;
the backlight unit comprising:
a first backlight unit being disposed with one of the short sides; and,
the first reflector element being disposed with in light emitting direction of the backlight unit, and the width of the first reflector element being less than the second reflector element.

2. The backlight module as claimed in claim 1, characterized in that the back plate comprises a position convex bump, wherein:
a position convex bump corresponding a via-hole which is disposed on the first reflector element;
the position convex bump positioning the first reflector element through the via-hole.

3. The backlight module as claimed in claim 1, characterized in that:
double-sided tape is applied to attach the second reflector element to the back plate.

4. A backlight module, which comprises:
a back plate, at least one backlight unit, and a reflector; wherein
the reflector being disposed on the back plate;
the back light unit being disposed with at least one side of the reflector;
the reflector comprising: a first reflector element and a second reflector element which are disposed with adjacently;
the first reflector element being disposed close to the backlight unit;
the second reflector element being disposed to attach to the first reflector element and being away from the backlight unit;
wherein the first reflector element and the second reflector element consisting of different materials; and,
as a result, the first reflector element being more heat resistant than the second reflector element.

5. The backlight module as claimed in claim 4, characterized in that:
the reflector comprises: two long sides being disposed parallely and two short sides being disposed parallely;
the two short sides being disposed vertically to the two long sides;
the backlight unit comprises:
a first backlight unit being disposed with one of the short sides.

6. The backlight module as claimed in claim 4, characterized in that:
the reflector comprises:
two long sides being disposed parallely and two short sides being disposed parallely;
the two short sides being disposed vertically to the two long sides; and,
the backlight unit comprises:
a first backlight unit being disposed with one of the long sides.

7. The backlight module as claimed in claim 4, characterized in that:
the reflector comprises:
two long sides being disposed parallely and two short sides being disposed parallely;
the two short sides being disposed vertically to the two long sides;
the backlight unit comprises:
a first backlight unit and a second backlight being disposed at the outer edges of two short sides respectively; and,
the second reflector element being disposed in between two first reflector elements.

8. The backlight module as claimed in claim 4, characterized in that:
the reflector comprises:
two long sides being disposed parallely and two short sides being disposed parallelly;
the two short sides being disposed vertically to the two long sides;
the backlight unit comprising: a first backlight unit and a second backlight being disposed at the outer edges of two long sides respectively; and,
the second reflector element being disposed in between two first reflector elements.

9. The backlight module as claimed in claim 4, characterized in that:
the first reflector element is disposed with in light emitting direction of the backlight unit; and,
the width of the first reflector element being less than the second reflector element.

10. The backlight module as claimed in claim 4, characterized in that:
the back plate comprises:
a position convex bump corresponding a via-hole which is disposed on the first reflector element; and,
the position convex bump positioning the first reflector element through the via-hole.

11. The backlight module as claimed in claim 4, characterized in that:
double-sided tape is applied to attach the second reflector element to the back plate.

12. A liquid crystal display device, which comprises:
a backlight module comprising a back plate, at least one backlight unit, and a reflector; wherein
the reflector being disposed on the back plate;
the back light unit being disposed with at least one side of the reflector;
the reflector comprising:
a first reflector element and a second reflector element which are disposed with adjacently;
the first reflector element being disposed close to the backlight unit; the second reflector element being disposed to attach to the first reflector element and being away from the backlight unit;
wherein the first reflector element and the second reflector element consisting of different materials; and,
as a result, the first reflector element being more heat resistant than the second reflector element.

13. The liquid crystal display device as claimed in claim 12, characterized in that:
the reflector comprises:
two long sides being disposed parallely and two short sides being disposed parallely;
the two short sides being disposed vertically to the two long sides; and,
the backlight unit comprising: a first backlight unit being disposed with one of the short sides.

14. The liquid crystal display device as claimed in claim 12, characterized in that:
the reflector comprises, two long sides being disposed parallely and two short sides being disposed parallely;
the two short sides being disposed vertically to the two long sides; and,
the backlight unit comprises:
a first backlight unit being disposed with one of the long sides.

15. The liquid crystal display device as claimed in claim 12, characterized in that:
the reflector comprises: two long sides being disposed parallely and two short sides being disposed parallely;
the two short sides being disposed vertically to the two long sides;
the backlight unit comprising: a first backlight unit and a second backlight being disposed at the outer edges of two short sides respectively; and,
the second reflector element being disposed in between two first reflector elements.

16. The liquid crystal display device as claimed in claim 12, characterized in that:
the reflector comprises:
two long sides being disposed parallely and two short sides being disposed parallely;
the two short sides being disposed vertically to the two long sides;
the backlight unit comprising: a first backlight unit and a second backlight being disposed at the outer edges of two long sides respectively; and,
the second reflector element being disposed in between two first reflector elements.

17. The liquid crystal display device as claimed in claim 12, characterized in that:
the first reflector element is disposed with in light emitting direction of the backlight unit; and,
the width of the first reflector element being less than the second reflector element.

18. The liquid crystal display device as claimed in claim 12, characterized in that:
the back plate comprises:
a position convex bump corresponding a via-hole which is disposed on the first reflector element; and,
the position convex bump positioning the first reflector element through the via-hole.

19. The liquid crystal display device as claimed in claim 12, characterized in that:
double-sided tape is applied to attach the second reflector element to the back plate.

20. A reflector, which comprises:
a first reflector element and a second reflector element;
wherein the first reflector element and the second reflector element consisting of different materials; and,
as a result, the first reflector element being more heat resistant than the second reflector element.
